(19) United States
(12) Patent Application Publication
(10) Pub. No.: US 2026/0050303 A1
(43) Pub. Date: Feb. 19, 2026

(54) COMPUTING SYSTEM

(71) Applicant: Delta Electronics (Thailand) Public Company Limited, Samutprakarn (TH)

(72) Inventors: Ralf Pieper, Soest (DE); Yichao Wang, Soest (DE); Kai Dong, Shanghai (CN)

(21) Appl. No.: 19/282,675

(22) Filed: Jul. 28, 2025

(30) Foreign Application Priority Data
Aug. 16, 2024 (CN) 202421996970.7

(51) Int. Cl. G06F 1/18; G06F 1/20

(52) U.S. Cl. CPC G06F 1/189; G06F 1/20; G06F 2200/201

(57) ABSTRACT

A computing system is provided. The computing system includes a load module, a power supply module and first horizontal busbars. The power supply module is configured to supply power to the load module, and includes power supply units arranged along a vertical direction. Each of the power supply units includes power supply subunits, and the power supply units are electrically connected through at least one power distribution busbar. Each first horizontal busbar is extended along a horizontal direction. The first horizontal busbars are configured to electrically connect the power supply units with the load module. The horizontal direction is perpendicular to the vertical direction. When any of the power supply units fails, the load module receives power from another one of the power supply units through a corresponding first horizontal busbar and a corresponding power distribution busbar.

### CROSS-REFERENCE TO RELATED APPLICATION

This application claims priority to China Patent Application No. 202421996970.7, filed on Aug. 16, 2024, the entire contents of which are incorporated herein by reference for all purposes.

### FIELD OF THE INVENTION

The present disclosure relates to a computing system, and more particularly to a computing system applied in data centers.

### BACKGROUND OF THE INVENTION

Conventional server racks typically employ a centralized power supply manner. As shown in FIG. 1, in conventional server racks, power supply units are disposed at the top and/or bottom of the server rack, and the load equipment located in the middle portion is powered through vertical busbars 100.

In practical applications, connectors are required to connect the power supply units and load equipments in the server rack to the busbars 100, and these connectors themselves occupy a certain amount of space. Additionally, gaps must be reserved between the busbars 100 during assembly. Moreover, a large number of network cables must be connected to the load equipments, which also occupy a lot space. Due to the size constraints of the server rack, the number of busbars 100 that can be installed is limited, resulting in limiting the total power limit of the server rack. This limitation may make it difficult to meet the demands of data centers.

Therefore, there is a need of providing a computing system in order to overcome the drawbacks of the conventional technologies.

### SUMMARY OF THE INVENTION

The present disclosure provides a computing system, which reduces the current density and increases the total power of the computing system by independently designing the power supply module and the load module and utilizing multiple sets of horizontal busbars for power delivery.

In accordance with an aspect of the present disclosure, a computing system is provided. The computing system includes a load module, a power supply module and first horizontal busbars. The power supply module is configured to supply power to the load module, and includes power supply units arranged along a vertical direction. Each of the power supply units includes power supply subunits, and the power supply units are electrically connected through at least one power distribution busbar. Each first horizontal busbar is extended along a horizontal direction. The first horizontal busbars are configured to electrically connect the power supply units with the load module. The horizontal direction is perpendicular to the vertical direction. When any of the power supply units fails, the load module receives power from another one of the power supply units through a corresponding first horizontal busbar and a corresponding power distribution busbar.

In an embodiment, the power supply subunits of each of the power supply units are stacked along the horizontal direction or the vertical direction.

In an embodiment, the load module includes load units arranged along the vertical direction.

In an embodiment, the load units and the power supply units arranged adjacent to each other in the horizontal direction are electrically connected through at least one corresponding first horizontal busbar, among the first horizontal busbars.

In an embodiment, each of the load units includes load subunits stacked along the vertical direction.

In an embodiment, the load subunits of each of the load units are electrically connected through at least one vertical busbar extended along the vertical direction.

In an embodiment, among the power supply subunits of each of the power supply units, at least one power supply subunit is in a standby mode, and the other power supply subunits are configured to supply power required by a corresponding load unit, among the load units.

In an embodiment, any two vertically adjacent power supply units, among the power supply units, are electrically connected through one of the at least one power distribution busbar.

In an embodiment, the power supply units are electrically connected through one said power distribution busbar.

In an embodiment, the power supply subunits of each of the power supply units are stacked along the horizontal direction and are electrically connected through at least one second horizontal busbar, and the at least one second horizontal busbar is extended along the horizontal direction and is connected to a corresponding first horizontal busbar, among the first horizontal busbars.

In an embodiment, the computing system further includes a load rack and a power supply rack, the load module is disposed in the load rack, the power supply module is disposed in the power supply rack, and the load rack and the power supply rack are arranged along the horizontal direction and are modularly connected to each other.

In an embodiment, the computing system includes a plurality of said power supply modules and a plurality of said power supply racks, a number of the plurality of power supply modules is equal to a number of the plurality of power supply racks, the plurality of power supply modules are disposed in the plurality of power supply racks respectively, the plurality of power supply racks are arranged along the horizontal direction, any two adjacent power supply racks, among the plurality of power supply racks, are modularly connected to each other, and the load rack is modularly connected to an adjacent power supply rack, among the plurality of power supply racks.

In an embodiment, the plurality of power supply racks are distributed on one side or two sides of the load rack.

In an embodiment, the computing system includes a plurality of said power supply modules, and power supply units in different power supply modules, among the plurality of power supply modules, at a same vertical height are electrically connected to the load module through one of the first horizontal busbars.

In an embodiment, the computing system includes a plurality of said power supply modules, and power supply units in different power supply modules, among the plurality of power supply modules, at a same vertical height are electrically connected to the load module through respective first horizontal busbars, among the first horizontal busbars.

In an embodiment, the load module and the power supply module are disposed in a same rack.

In an embodiment, the computing system further includes a power distribution device, the power distribution device is electrically connected between an input power source and the power supply module and is configured to distribute an electric power provided by the input power source to the power supply units of the power supply module.

In an embodiment, the load module includes load units arranged along the vertical direction, the computing system further includes a liquid cooling device configured to cool each of the power supply units and/or each of the load units, and the liquid cooling device includes a liquid storage unit, a water inlet main pipe, water inlet branch pipes, water outlet branch pipes and a water outlet main pipe. The liquid storage unit is configured to store coolant. The water inlet main pipe is connected to the liquid storage unit. Two terminals of each of the water inlet branch pipes are respectively connected to the water inlet main pipe and a water inlet joint of a corresponding power supply unit, among the power supply units, and/or a corresponding load unit, among the load units, so as to deliver the coolant to cool the corresponding power supply unit and/or the corresponding load unit. Each water outlet branch pipe is connected to a water outlet joint of the corresponding power supply unit and/or the corresponding load unit. The water outlet main pipe is connected between the liquid storage unit and the water outlet branch pipes. The coolant discharged from the water outlet joint is returned to the liquid storage unit through a corresponding water outlet branch pipe, among the water outlet branch pipes, and the water outlet main pipe.

In an embodiment, each of the power supply subunits includes a power conversion unit with an automatic transfer switch for dual-input power sources.

In an embodiment, among the power supply subunits of each of the power supply units, at least one power supply subunit is a power conversion unit including an energy storage unit, and an output power of the at least power supply subunit is the same as an output power of the other power supply subunits.

### BRIEF DESCRIPTION OF THE DRAWINGS

FIG. 1 is a schematic block diagram illustrating a conventional server rack;

FIG. 2A is a schematic block diagram illustrating a computing system according to an embodiment of the present disclosure;

FIG. 2B is a schematic block diagram illustrating a computing system according to another embodiment of the present disclosure;

FIG. 2C is a schematic block diagram illustrating a computing system according to further another embodiment of the present disclosure;

FIGS. 3, 4, 5 and 6 exemplify various kinds of variants of the computing system shown in FIG. 2C;

FIGS. 7, 8, 9, 10 and 11 are schematic block diagrams illustrating various implementations in which the load module and the power supply module of the computing system of the present disclosure are disposed in rack(s); and

FIG. 12 is a schematic view illustrating the implementation of cooling the load module and the power supply module by liquid cooling device.

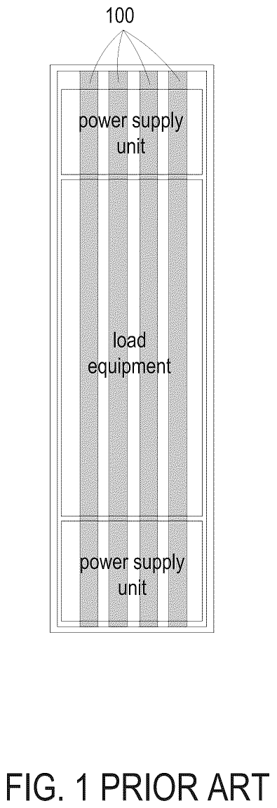

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

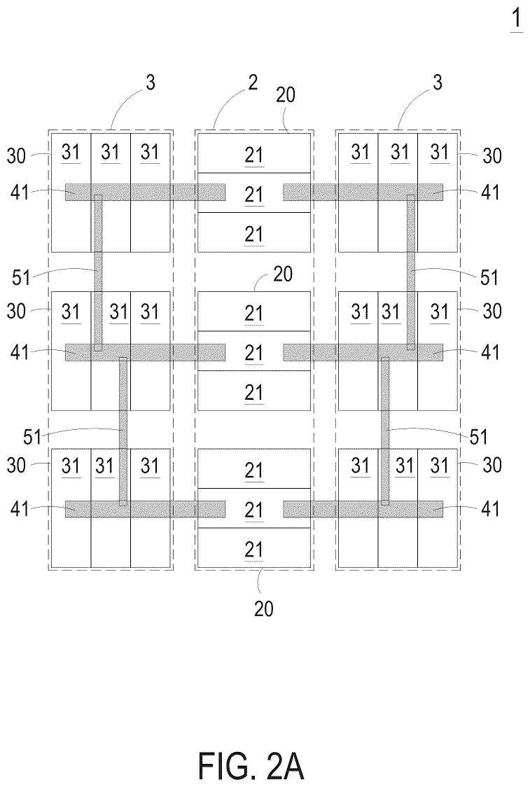

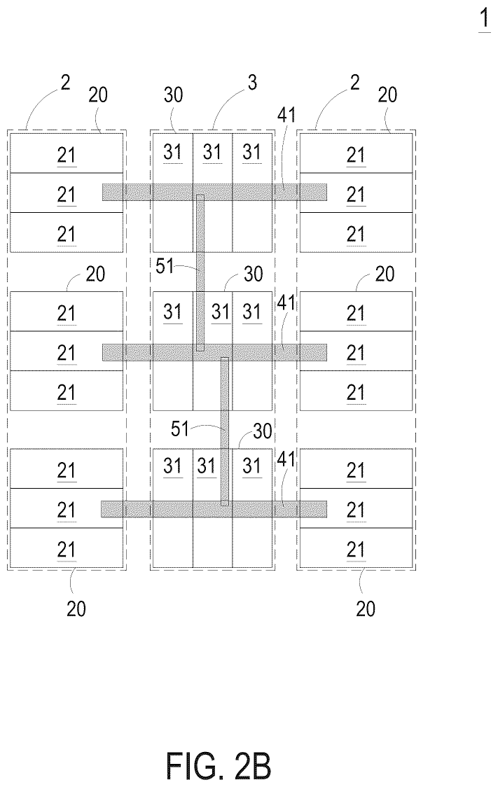

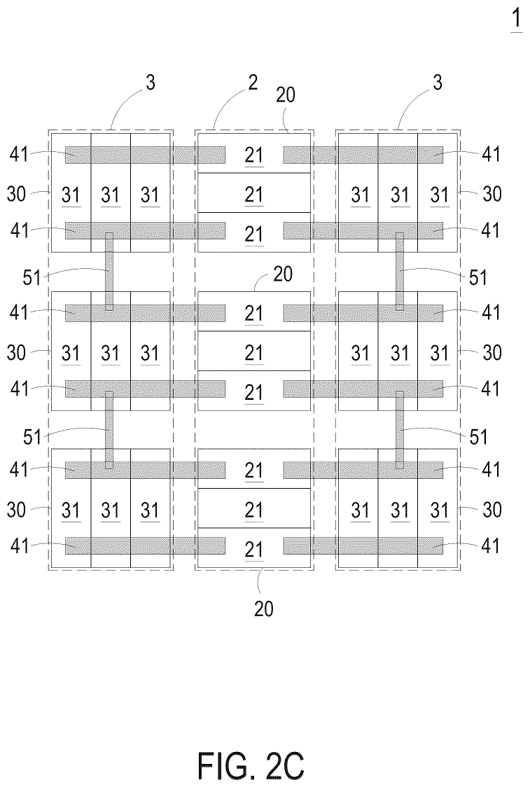

FIG. 2A is a schematic block diagram illustrating a computing system according to an embodiment of the present disclosure. As shown in FIG. 2A, the computing system 1 includes a load module 2, a power supply module 3, and a plurality of first horizontal busbars 41. In FIG. 2A, the computing system 1 is illustrated with one load module 2 and two power supply modules 3 as an example. However, it should be understood that the numbers of load modules 2 and power supply modules 3 are not limited and may be one or more for either module. For example, FIG. 2B exemplifies an embodiment of the computing system 1 including two load modules 2 and one power supply module 3. The structure and function of the load module 2 and power supply module 3 in FIG. 2B are the same as those in FIG. 2A, and thus the following description would focus on FIG. 2A as an example.

As shown in FIG. 2A. The load module 2 includes a plurality of load units 20 arranged along a vertical direction, and each load unit 20 includes a plurality of load subunits 21 stacked along the vertical direction. For simplicity, the diagram depicts the load module 2 including three load units 20 with each load unit 20 including three load subunits 21 as an example. However, in fact, the number of load units 20 and the number of load subunits 21 are not limited. The load subunit 21 may be any component that consumes electrical power, for example but not limited to a server, a computing equipment, a storage equipment or a network equipment.

The power supply module 3 is configured to supply power to the load module 2 and includes a plurality of power supply units 30 arranged along the vertical direction. Each power supply unit 30 includes a plurality of power supply subunits 31. For instance, in this embodiment, the plurality of power supply subunits 31 are stacked along a horizontal direction such that the first horizontal busbar 41 is used for connecting the power supply unit 30 and the load unit 20. It should be understood that the plurality of power supply subunits 31 included by each power supply unit 30 can alternatively be stacked along the vertical direction, where the vertical direction is perpendicular to the above-mentioned horizontal direction. The plurality of power supply units 30 are electrically connected through at least one power distribution busbar 51, thereby allowing energy distribution among the power supply units 30 via the power distribution busbar 51. Therefore, the flexibility and reliability of the overall system are enhanced. In addition, although two power supply modules 3 are shown in the diagram, the actual number of power supply modules 3 included by the computing system 1 is not limited and may be adjusted according to actual requirements. For simplicity, the diagram depicts the power supply module 3 including three power supply units 30 with each power supply unit 30 including three power supply subunits 31 as an example. However, in fact, the number of power supply units 30 and the number of power supply subunits 31 are not limited. Further, the number of power supply units 30 and the number of power supply subunits 31 may exceed the minimum number of load requirements to provide redundant power. In an embodiment, in each power supply unit 30, at least one power supply subunit 31 is in standby mode, while the other power supply subunits 31 supply the power required by the corresponding load unit 20. For example, in each power supply unit 30, there may be N power supply subunits 31 used to supply the power required by the corresponding load unit 20, and there may be M power supply subunits 31 in the standby mode. Namely, the power supply unit 30 has a redundant configuration of N+M. Additionally, the specific implementation of the power supply subunits 31 is not limited. In an embodiment, in each power supply unit 30, at least one power supply subunit 31 is a power conversion unit which includes an energy storage unit, and its output power is the same as the output power of the other power supply subunits 31. In another embodiment, the power supply subunit 31 may adopt a power conversion unit with an automatic transfer switch for dual-input power sources to enhance reliability. In yet another embodiment, the power supply subunit 31 may simply adopt a power conversion unit connected to a single power source.

The first horizontal busbar 41 extends along the horizontal direction, and the load unit 20 and power supply unit 30 adjacent to each other are arranged along the horizontal direction and are electrically connected to each other through the corresponding first horizontal busbar 41. In the embodiment shown in FIG. 2A, during normal operation, the load unit 20 is powered by two adjacent power supply units 30 through the first horizontal busbars 41. This design reduces the current capacity requirement of the first horizontal busbar 41. If any power supply unit 30 fails, the load unit 20 adjacent to the failed power supply unit 30 can receive power from other power supply units 30 through the corresponding first horizontal busbar 41 and power distribution busbar 51. Accordingly, the reliability of the computing system 1 is enhanced. In addition, in this embodiment, power supply units 30 in different power supply modules 3 at the same vertical height are electrically connected to the corresponding load unit 20 through respective first horizontal busbars 41. Of course, in order to reduce the current density on the busbar and increase the power capacity provided by each power supply unit 30, each power supply unit 30 may be connected to the corresponding load unit 20 through multiple first horizontal busbars 41. For instance, as shown in FIG. 2C, each power supply unit 30 is connected to the corresponding load unit 20 through two first horizontal busbars 41. Further, each first horizontal busbar 41 is actually formed by two parallel busbars, where one busbar is used for transmitting positive voltage and the other busbar is used for transmitting negative voltage. These two parallel busbars are structurally isolated but work cooperatively in an electrical sense. It should be understood that the first horizontal busbar 41 may be a bus bar (such as a copper bar or an aluminum bar) or a cable, as long as it can facilitate electrical transmission. Similarly, each power distribution busbar 51 is actually formed by two parallel power distribution busbars for transmitting positive and negative voltages respectively, and these two parallel power distribution busbars are structurally isolated but work cooperatively in an electrical sense. Unless explicitly stated otherwise, this structure applies to all horizontal and vertical busbars and power distribution busbars described in the present disclosure.

From the above, the present disclosure achieves lower current density and higher total power of the computing system 1 by independently disposing the power supply module 3 from the load module 2 and utilizing multiple first horizontal busbars 41 for power delivery.

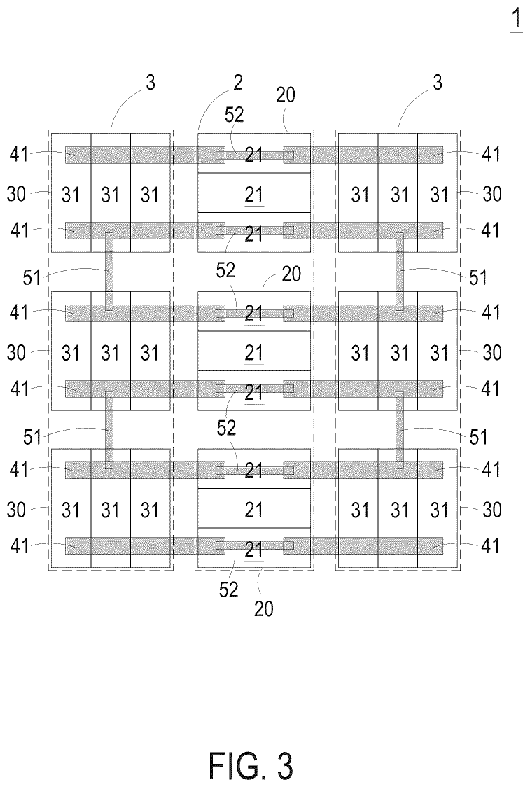

FIGS. 3, 4, 5 and 6 exemplify various kinds of variants of the computing system 1 shown in FIG. 2C. In FIGS. 3-6, the components having similar structures and functions as that in FIG. 2C are designated by identical numeral references, and detailed descriptions thereof are omitted herein.

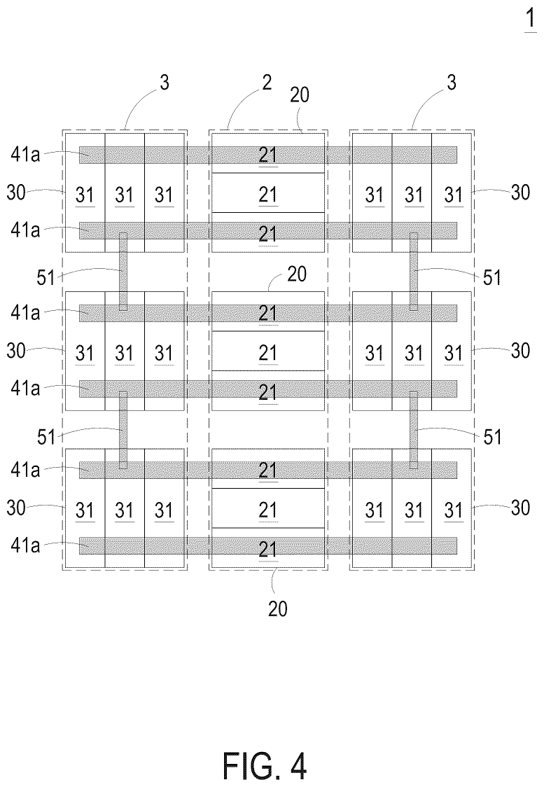

Under the circumstance that the computing system 1 includes a plurality of power supply modules 3, the way of electrically connecting power supply units 30 in different power supply modules 3 is not limited. For example, in an embodiment, as shown in FIG. 2C, when two power supply modules 3 are located on two sides of the load module 2 respectively, power supply units 30 in different power supply modules 3 at the same vertical height may be electrically connected through the corresponding first horizontal busbars 41 and the internal circuits within the load unit 20. In another embodiment, as shown in FIG. 3, the computing system 1 further includes power distribution busbars 52. In this case, when two power supply modules 3 are located on two sides of the load module 2 respectively, two first horizontal busbars 41 at the same vertical height may be electrically connected through the corresponding power distribution busbar 52, which extends along the horizontal direction. This allows the power supply units 30 at the same vertical height to be electrically connected through the corresponding first horizontal busbars 41 and power distribution busbar 52. Compared to FIG. 2C, this configuration increases redundancy. If any power supply unit 30 fails, the load unit 20 adjacent to the failed power supply unit 30 can still receive power from other power supply units 30 on both sides through the corresponding first horizontal busbars 41, power distribution busbars 51, and/or power distribution busbars 52. In addition, under the circumstance that any two power supply modules 3 are disposed neighboring to each other, in these two adjacent power supply modules 3, the power supply units 30 at the same vertical height may be electrically connected through the power distribution busbar 52. In another embodiment, as shown in FIG. 4, the power supply units 30 in different power supply modules 3 at the same vertical height may be electrically connected to the corresponding load unit 20 through the same first horizontal busbar 41a.

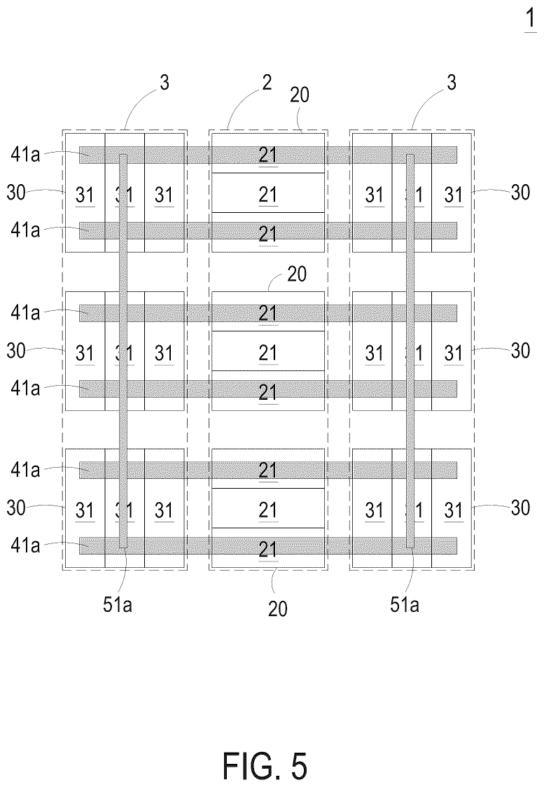

In some embodiments, the power supply module 3 includes a plurality of power supply units 30, the way of electrically connecting the plurality of power supply units 30 in the same power supply module 3 is not limited. For example, as shown in FIGS. 2A, 2C, 3 and 4, any two adjacent power supply units 30 in the same power supply module 3 are electrically connected through one power distribution busbar 51. In another embodiment, as shown in FIG. 5, all supply units 30 in the same power supply module 3 are electrically connected through one power distribution busbar 51a.

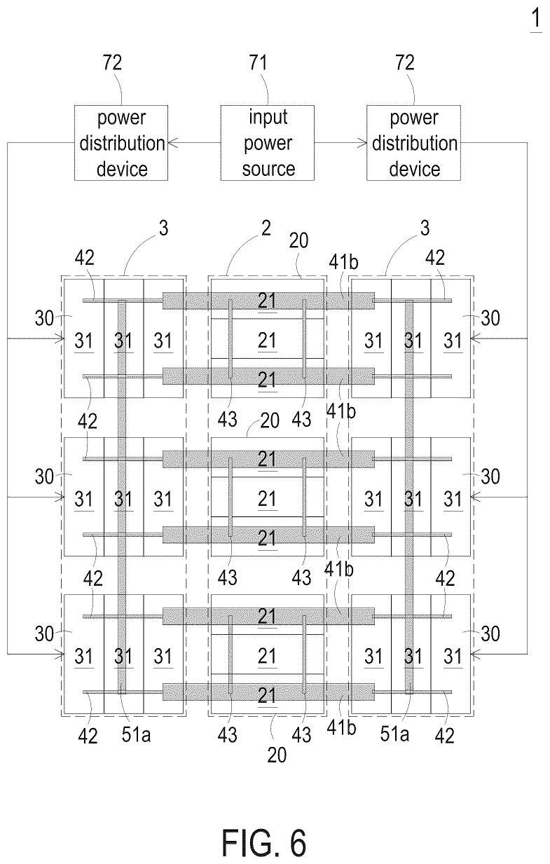

It should be understood that the connection between the first horizontal busbar and the power supply unit 30 mentioned above means electrical connection. Under the circumstance that each power supply unit 30 includes a plurality of power supply subunits 31, the way of electrically connecting the plurality of power supply subunits 31 in the same power supply unit 30 is not limited, as long as the plurality of power supply subunits 31 in the same power supply unit 30 are electrically connected with each other through the corresponding first horizontal busbar 41 or 41a. Further, the way of connecting the power supply subunit and the first horizontal busbar is not limited. In an embodiment, output terminals of the power supply subunits may be respectively connected to the first horizontal busbar. In another embodiment, the output terminals of the power supply subunits may first be interconnected and then connected to the first horizontal busbar. As shown in FIG. 6, the computing system 1 further includes a second horizontal busbar 42. The plurality of power supply subunits 31 in the same power supply unit 30 are electrically connected through the corresponding second horizontal busbar 42, which extends along the horizontal direction and is electrically connected to the corresponding first horizontal busbar 41b. The first horizontal busbar 41b is configured to connect the load unit 20 with the adjacent power supply unit 30. To prevent excessive current concentration at the connection point between the first horizontal busbar 41b and the second horizontal busbar 42, the first horizontal busbar 41b may be extended to increase its connection area with second horizontal busbar 42.

If each load unit 20 includes a plurality of load subunits 21, the way of electrically connecting the plurality of load subunits 21 in the same load unit 20 is not limited. For instance, in an embodiment, as shown in FIG. 6, the computing system 1 further includes a vertical busbar 43. The plurality of load subunits 21 of each load unit 20 are electrically connected through the vertical busbar 43, which extends along the vertical direction.

Additionally, in an embodiment, as shown in FIG. 6, the computing system 1 further includes an input power source 71 and a power distribution device 72, where the input power source 71 is an AC power source. The power distribution device 72 is electrically connected between the input power source 71 and the power supply module 3, and is configured to distribute the electric power provided by the input power source 71 to all power supply units 30 of the power supply module 3. It should be understood that each power supply subunit 31 may receive a single-phase or three-phase power source. Of course, the said input power source 71 and power distribution device 72 may also be applied to the embodiments shown in FIG. 2A to FIG. 5. If the input power source 71 is a DC power source, the power distribution device is unnecessary.

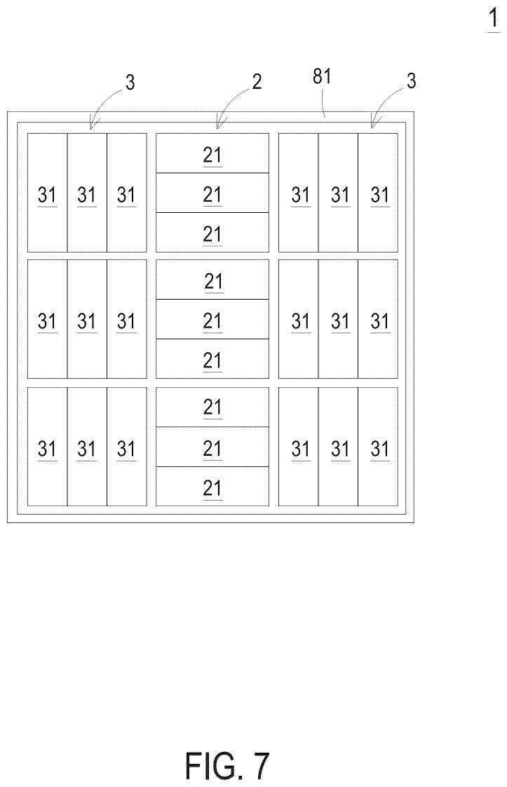

FIG. 7 is a schematic block diagram illustrating an implementation in which the load module 2 and the power supply module 3 of the computing system of the present disclosure are disposed in a rack. For simplicity, the horizontal and vertical busbars and the power distribution busbars used for electrical connections are omitted in FIG. 7. In practical applications, the configuration of the horizontal and vertical busbars and the power distribution busbars in any of the foregoing embodiments may be adopted in the implementation of FIG. 7. In an embodiment, as shown in FIG. 7, the computing system 1 further includes a rack 81, and the load module 2 and all power supply modules 3 are disposed in the same rack 81.

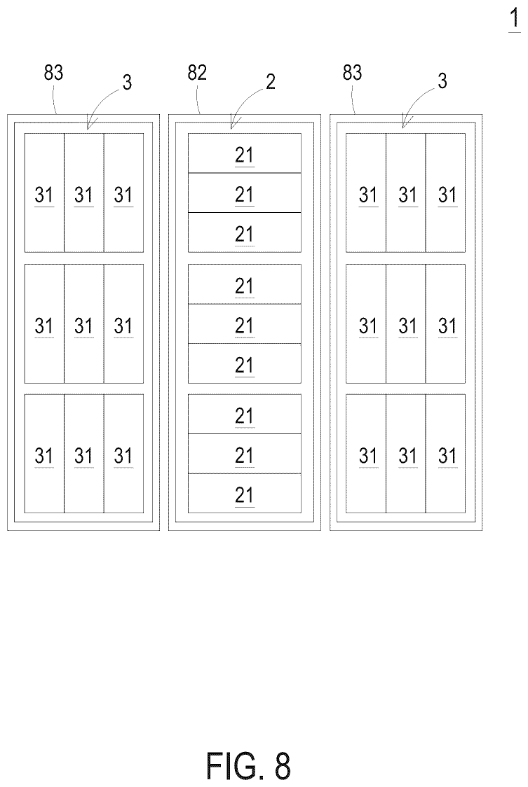

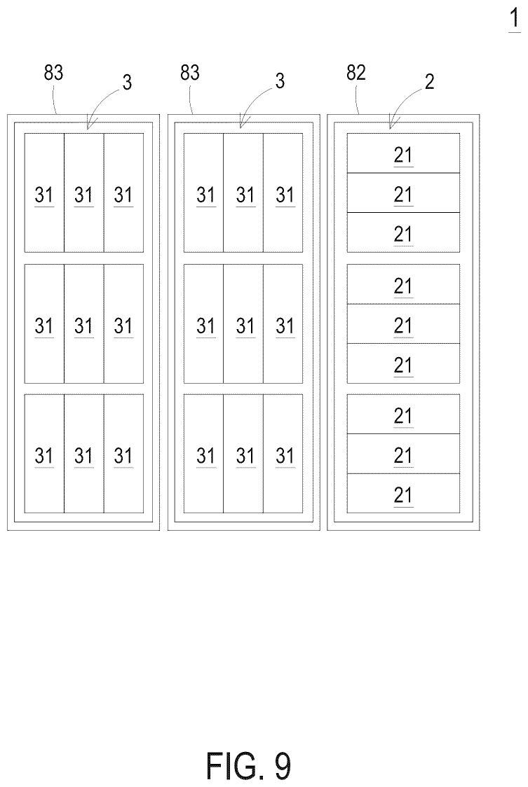

It is noted that the present disclosure is not limited thereto, namely the load module 2 and the power supply module 3 may be disposed in separate racks. In another embodiment, as shown in FIG. 8, the computing system 1 further includes a load rack 82 and a plurality of power supply racks 83. The load module 2 is disposed in the load rack 82, the plurality of power supply modules 3 are disposed in the plurality of power supply racks 83 respectively, and the load rack 82 and all power supply racks 83 are arranged along the horizontal direction. It is noted that the number of power supply racks 83 is equal to the number of power supply modules 3. For example, if the computing system 1 includes only one power supply module 3, the computing system 1 includes only one power supply rack 83. In addition, in this embodiment, the plurality of power supply racks 83 are distributed on two sides of the load rack 82. Preferably, when the number of power supply modules 3 and power supply racks 83 is even, the power supply racks 83 are symmetrically distributed on the two sides of the load rack 82. The load rack 82 is modularly connected to the adjacent power supply racks 83. In yet another embodiment, as shown in FIG. 9, the plurality of power supply racks 83 may be disposed on only one side of the load rack 82. Any two adjacent power supply racks 83 are modularly connected to each other, and the load rack 82 is modularly connected to the adjacent power supply rack 83. By disposing the load module 2 and power supply module 3 in respective racks, the number of power supply modules 3 and corresponding power supply racks 83 may be expanded as needed in practical applications, thereby effectively improving the scalability of the computing system 1.

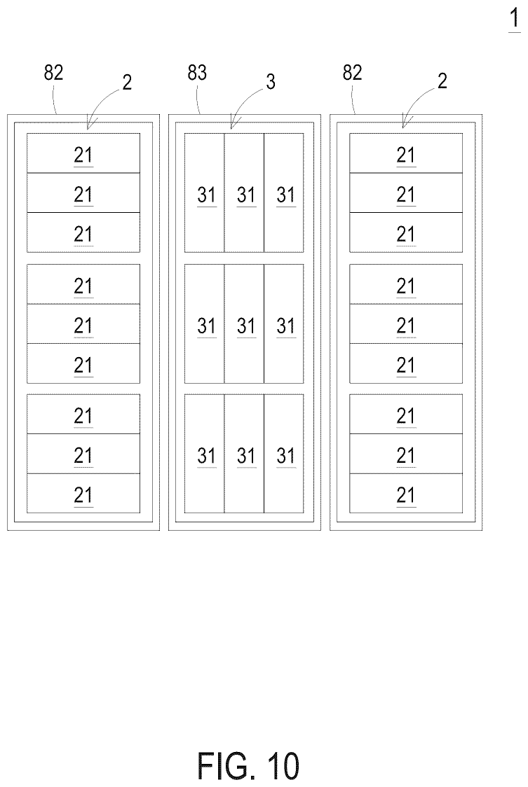

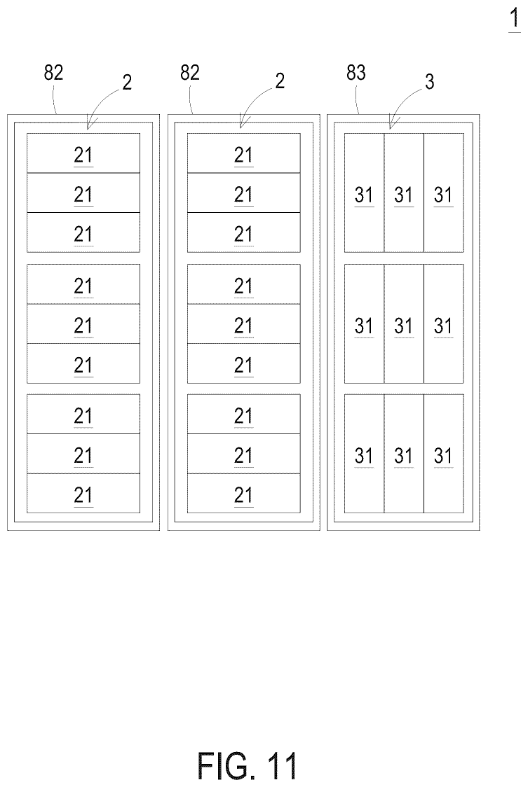

Moreover, the numbers of load modules 2 and power supply modules 3 are not limited. In another embodiment, as shown in FIG. 10, the computing system 1 includes a plurality of load racks 82 and a power supply rack 83. A plurality of load modules 2 are disposed in the plurality of load racks 82 respectively, the power supply module 3 is disposed in the power supply rack 83, and all load racks 82 and the power supply rack 83 are arranged along the horizontal direction. The number of load racks 82 is equal to the number of load modules 2. Additionally, in this embodiment, the load racks 82 are distributed on two sides of the power supply rack 83. Preferably, when the number of load modules 2 and load racks 82 is even, the load racks 82 are symmetrically distributed on the two sides of the power supply rack 83. The power supply rack 83 is modularly connected to the adjacent load racks 82. In yet another embodiment, as shown in FIG. 11, the plurality of load racks 82 may be disposed on only one side of the power supply rack 83. Any two adjacent load racks 82 are modularly connected to each other, and the power supply rack 83 is modularly connected to the adjacent load rack 82.

The way of assembling racks is not limited and may include, for example, snap connections, bolt connections, or latch connections. For instance, connection components may be reserved on the racks, enabling adjacent racks to be modularly connected to each other through these connection components.

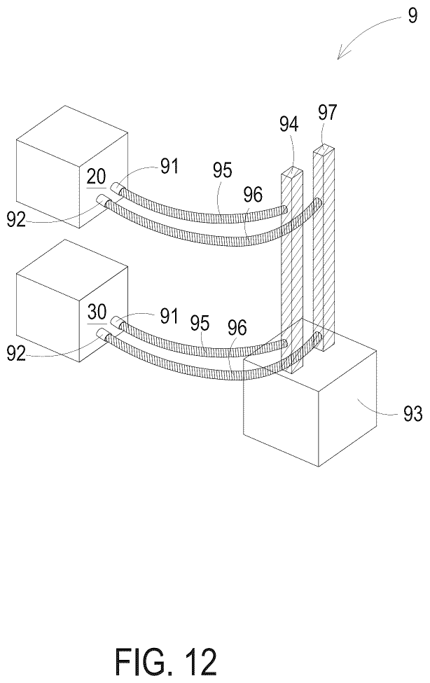

In addition, the load units 20 and/or the power supply units 30 in the computing system 1 may adopt appropriate cooling solutions, such as air cooling or liquid cooling. For air cooling, fans may be disposed inside each unit. In an embodiment, each of the load subunits 21 and power supply subunits 31 has a fan disposed internally. For liquid cooling, as shown in FIG. 12, the computing system 1 includes a liquid cooling device 9, and each load unit 20 and/or each power supply unit 30 is equipped with a water inlet joint 91 and a water outlet joint 92. It should be understood that the positions of the water inlet joint and the water outlet joint may vary. They may be disposed on individual power supply subunit and/or load subunit, or may be shared among multiple power supply subunits and/or load subunits. FIG. 12 only serve as an example. In this embodiment, the liquid cooling device 9 is used to cool both the load units 20 and the power supply units 30 simultaneously. However, in practice, it is also feasible to utilize multiple liquid cooling devices 9 to cool the load units 20 and power supply units 30 separately.

The liquid cooling device 9 includes a liquid storage unit 93, a water inlet main pipe 94, a plurality of water inlet branch pipes 95, a plurality of water outlet branch pipes 96, and a water outlet main pipe 97. The liquid storage unit 93 is configured to store the coolant. The water inlet main pipe 94 is connected to the liquid storage unit 93 to receive the coolant. The liquid storage unit 93 includes a pump to provide power for the coolant flow. Two terminals of each water inlet branch pipe 95 are respectively connected to the water inlet main pipe 94 and a corresponding water inlet joint 91, thereby delivering coolant to the corresponding load unit 20 and/or power supply unit 30 for cooling. Two terminals of each water outlet branch pipe 96 are respectively connected to the water outlet main pipe 97 and a corresponding water outlet joint 92. The water outlet main pipe 97 is connected between the liquid storage unit 93 and all water outlet branch pipes 96. The coolant discharged from the water outlet joint 92 is returned to the liquid storage unit 93 through the corresponding water outlet branch pipe 96 and the water outlet main pipe 97. It is noted that in practical applications, the liquid storage unit 93, the water inlet main pipe 94 and the water outlet main pipe 97 of the liquid cooling device 9 may be disposed in any load rack 82 or power supply rack 83, or in an independent rack.

In summary, the present disclosure provides a computing system in which the plural subunits of the power supply unit are stacked along the horizontal direction such that the horizontal busbars are used for connecting the power supply units and load units. Moreover, multiple sets of horizontal busbars are used for power delivery, thereby reducing the current density and increasing the upper limit of the total power of the computing system. Furthermore, the load module and the power supply module are disposed in respective racks, and the number of power supply modules and corresponding power supply racks may be expanded according to actual requirements, thereby effectively improving the scalability of the computing system.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A computing system, comprising:
a load module;
a power supply module, configured to supply power to the load module, and comprising power supply units arranged along a vertical direction, wherein each of the power supply units comprises power supply subunits, and the power supply units are electrically connected through at least one power distribution busbar; and
first horizontal busbars, each being extended along a horizontal direction, wherein the first horizontal busbars are configured to electrically connect the power supply units with the load module, and the horizontal direction is perpendicular to the vertical direction,
wherein when any of the power supply units fails, the load module receives power from another one of the power supply units through a corresponding first horizontal busbar, among the first horizontal busbars, and a corresponding power distribution busbar, among the at least one power distribution busbar.

2. The computing system according to claim 1, wherein the power supply subunits of each of the power supply units are stacked along the horizontal direction or the vertical direction.

3. The computing system according to claim 1, wherein the load module comprises load units arranged along the vertical direction.

4. The computing system according to claim 3, wherein the load units and the power supply units arranged adjacent to each other in the horizontal direction are electrically connected through at least one corresponding first horizontal busbar, among the first horizontal busbars.

5. The computing system according to claim 3, wherein each of the load units comprises load subunits stacked along the vertical direction.

6. The computing system according to claim 5, wherein the load subunits of each of the load units are electrically connected through at least one vertical busbar extended along the vertical direction.

7. The computing system according to claim 3, wherein among the power supply subunits of each of the power supply units, at least one power supply subunit is in a standby mode, and the other power supply subunits are configured to supply power required by a corresponding load unit, among the load units.

8. The computing system according to claim 1, wherein any two vertically adjacent power supply units, among the power supply units, are electrically connected through one of the at least one power distribution busbar.

9. The computing system according to claim 1, wherein the power supply units are electrically connected through one said power distribution busbar.

10. The computing system according to claim 1, wherein the power supply subunits of each of the power supply units are stacked along the horizontal direction and are electrically connected through at least one second horizontal busbar, and the at least one second horizontal busbar is extended along the horizontal direction and is connected to a corresponding first horizontal busbar, among the first horizontal busbars.

11. The computing system according to claim 1, further comprising a load rack and a power supply rack, wherein the load module is disposed in the load rack, the power supply module is disposed in the power supply rack, and the load rack and the power supply rack are arranged along the horizontal direction and are modularly connected to each other.

12. The computing system according to claim 11, wherein the computing system comprises a plurality of said power supply modules and a plurality of said power supply racks, a number of the plurality of power supply modules is equal to a number of the plurality of power supply racks, the plurality of power supply modules are disposed in the plurality of power supply racks respectively, the plurality of power supply racks are arranged along the horizontal direction, any two adjacent power supply racks, among the plurality of power supply racks, are modularly connected to each other, and the load rack is modularly connected to an adjacent power supply rack, among the plurality of power supply racks.

13. The computing system according to claim 12, wherein the plurality of power supply racks are distributed on one side or two sides of the load rack.

14. The computing system according to claim 1, wherein the computing system comprises a plurality of said power supply modules, and power supply units in different power supply modules, among the plurality of power supply modules, at a same vertical height are electrically connected to the load module through one of the first horizontal busbars.

15. The computing system according to claim 1, wherein the computing system comprises a plurality of said power supply modules, and power supply units in different power supply modules, among the plurality of power supply modules, at a same vertical height are electrically connected to the load module through respective first horizontal busbars, among the first horizontal busbars.

16. The computing system according to claim 1, wherein the load module and the power supply module are disposed in a same rack.

17. The computing system according to claim 1, further comprising a power distribution device, wherein the power distribution device is electrically connected between an input power source and the power supply module and is configured to distribute an electric power provided by the input power source to the power supply units of the power supply module.

18. The computing system according to claim 1, wherein the load module comprises load units arranged along the vertical direction, the computing system further comprises a liquid cooling device configured to cool each of the power supply units and/or each of the load units, and the liquid cooling device comprises:
a liquid storage unit, configured to store coolant;
a water inlet main pipe, connected to the liquid storage unit;
water inlet branch pipes, wherein two terminals of each of the water inlet branch pipes are respectively connected to the water inlet main pipe and a water inlet joint of a corresponding power supply unit, among the power supply units, and/or a corresponding load unit, among the load units, so as to deliver the coolant to cool the corresponding power supply unit and/or the corresponding load unit;
water outlet branch pipes, each being connected to a water outlet joint of the corresponding power supply unit and/or the corresponding load unit; and
a water outlet main pipe, connected between the liquid storage unit and the water outlet branch pipes, wherein the coolant discharged from the water outlet joint is returned to the liquid storage unit through a corresponding water outlet branch pipe, among the water outlet branch pipes, and the water outlet main pipe.

19. The computing system according to claim 1, wherein each of the power supply subunits comprises a power conversion unit with an automatic transfer switch for dual-input power sources.

20. The computing system according to claim 1, wherein among the power supply subunits of each of the power supply units, at least one power supply subunit is a power conversion unit comprising an energy storage unit, and an output power of the at least power supply subunit is the same as an output power of the other power supply subunits.
